(19) United States
(12) Patent Application Publication
(10) Pub. No.: US 2020/0137409 A1
(43) Pub. Date: Apr. 30, 2020

(54) FRAME EXTRAPOLATION VIA MOTION VECTORS

(71) Applicant: Microsoft Technology Licensing, LLC, REDMOND, WA (US)

(72) Inventors: Ashraf Ayman MICHAIL, Kirkland, WA (US); Michael George BOULTON, Seattle, WA (US)

(73) Assignee: Microsoft Technology Licensing, LLC, Redmond, WA (US)

(21) Appl. No.: 16/171,969

(22) Filed: Oct. 26, 2018

(51) Int. Cl. H04N 19/513; H04N 19/139; H04N 19/59; H04N 19/176

(52) U.S. Cl. CPC H04N 19/513; H04N 19/176; H04N 19/59; H04N 19/139

(57) ABSTRACT

Examples are disclosed that relate to producing an extrapolated frame based on motion vectors. One example provides a computing device comprising a logic machine and a storage machine comprising instructions executable by the logic machine to, for each block of one or more blocks of pixels in rendered image data, generate a motion vector indicating motion between a current frame and a prior frame, and for each block of the one or blocks, extrapolate a predicted block of pixels from the current frame based on the motion vector and one or more prior motion vectors for the block, the one or more prior motion vectors determined via one or more corresponding frames preceding the prior frame. The instructions are further executable to produce an extrapolated frame comprising the predicted block of pixels for each block of the one or more blocks, and display the extrapolated frame.

### BACKGROUND

Head-mounted display devices enable immersive experiences in which the appearance of a surrounding physical environment is modified by virtual imagery. To achieve a consistently immersive and convincing experience, head-mounted display devices may display virtual imagery at relatively high framerates.

### SUMMARY

Examples are disclosed that relate to mitigating artifacts produced when generating an extrapolated frame to preserve a target frame rate. One example provides a computing device comprising a logic machine and a storage machine comprising instructions executable by the logic machine to, for each block of one or more blocks of pixels in rendered image data, generate a motion vector indicating motion between a current frame and a prior frame, and for each block of the one or blocks, extrapolate a predicted block of pixels from the current frame based on the motion vector and one or more prior motion vectors for the block, the one or more prior motion vectors determined via one or more corresponding frames preceding the prior frame. The instructions are further executable to produce an extrapolated frame comprising the predicted block of pixels for each block of the one or more blocks, and display the extrapolated frame.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A shows an example head-mounted display device.

FIG. 1B shows example visual artifacts displayed on the head-mounted display device of FIG. 1A arising from frame extrapolation.

FIG. 2 shows a block diagram of an example frame extrapolation pipeline configured to extrapolate frames using unprocessed motion vectors obtained from a video encoder.

FIG. 3 shows a block diagram of an example extrapolation pipeline configured to extrapolate frames using processed motion vectors.

FIG. 4 shows a block diagram illustrating an example motion vector processor.

FIGS. 5A-5B illustrate examples of spatial correspondence among motion vectors.

FIG. 6 illustrates an example of temporal correspondence among motion vectors.

FIG. 7 shows a flowchart illustrating an example method of producing an extrapolated frame.

FIG. 8 shows a block diagram of an example computing system.

### DETAILED DESCRIPTION

Head-mounted display (HMD) devices enable immersive experiences in which the appearance of a surrounding physical environment is augmented by or replaced with virtual imagery. To achieve a consistently immersive and convincing experience, HMD devices may display virtual imagery as a sequence of frames at relatively high framerates (e.g., 90 frames per second or greater).

In some instances, computing hardware (e.g., a graphics processing unit and a central processing unit) rendering virtual imagery may be unable to meet a target framerate for displaying the virtual imagery on an HMD device. Failing to meet the target framerate may negatively impact an HMD use experience. Thus, the HMD device may employ various strategies for mitigating drops below the target framerate.

One such strategy extrapolates frames that cannot be rendered in time to meet a target framerate. In this strategy, a computing device may computationally identify motion between a most recent frame and a previous frame (for example, via video encoder that computes motion vectors), and extrapolate a subsequent frame using the identified motion. The extrapolated frame can then be displayed so that the preceding frame does not appear to be repeated, thereby maintaining the target framerate.

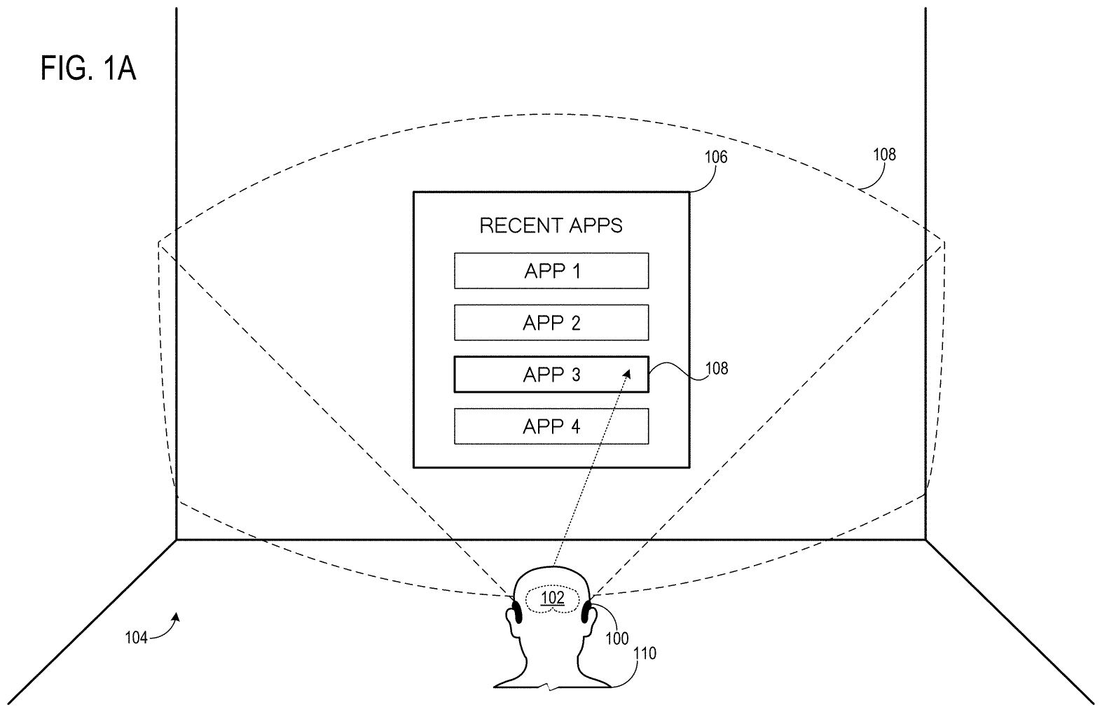

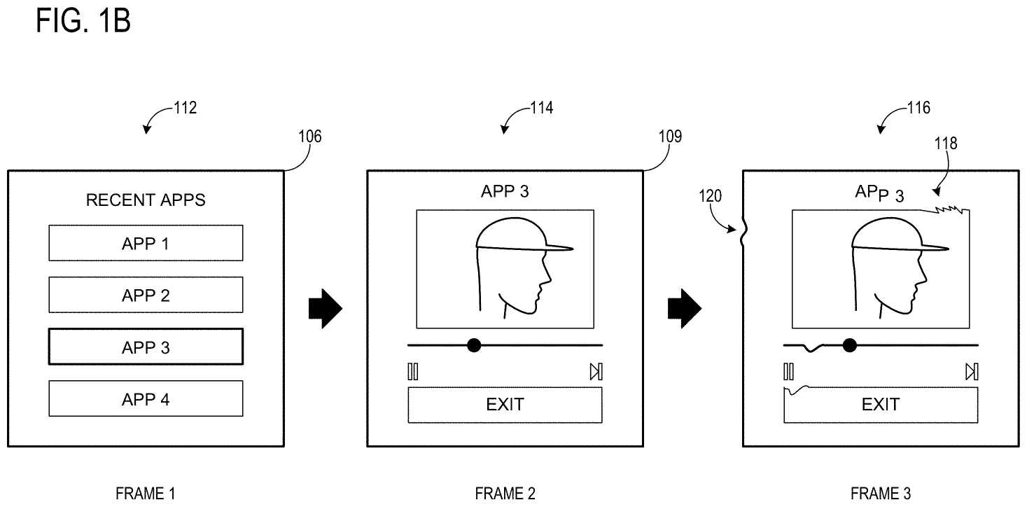

However, in various instances, the extrapolation of frames may produce visual artifacts that are disruptive to immersion and the user experience, as the identified motion may not match the actual motion in the displayed imagery. FIGS. 1A and 1B illustrate an example of such artifacts. First, FIG. 1A shows an example HMD device 100 including a display 102 with which virtual imagery is presented as part of an immersive experience. Display 102 may take the form of an at least partially transparent see-through display on which both virtual imagery and real imagery corresponding to a surrounding physical environment 104 combine to produce a mixed reality presentation. In other examples, display 102 may include an opaque display that substantially replaces a view of the physical environment with virtual imagery as part of a virtual reality presentation. Virtual imagery may be generated by any suitable computing hardware, such as a graphics processing unit (GPU) and a central processing unit (CPU) integrated within or external to HMD device 100.

In FIG. 1A, the virtual imagery rendered on display 102 includes a graphical user interface (GUI) 106. GUI 106 includes a list of selectable controls (e.g., control 108) corresponding to applications recently executed on HMD device 100. As shown, control 108 is selected based on the gaze direction of a wearer 110 of HMD device 100 intersecting the control. The examples described herein may apply to any suitable virtual imagery and input modality, however, as well as other display types including non-HMD devices and two-dimensional displays (e.g., displays that do not modify the appearance of a physical environment).

FIG. 1B illustrates the result of selecting control 108 in a sequence of frames of virtual imagery displayed on HMD device 100. In a first frame 112 of the sequence of frames, GUI 106 including control 108 is displayed. First frame 112 represents the virtual imagery rendered on display 102 of HMD device 100 in FIG. 1A, and shows GUI 106 immediately prior to the selection of control 108. The selection of control 108 results in the rendering of an application window 109 for an application opened by the selection of control 108.

HMD device 100 attempts to render a third frame 116, but determines that the third frame will not be rendered in time to meet a target framerate established for displaying frames. As such, third frame 116 is instead extrapolated by applying motion vectors determined based upon first frame 112 and second frame 114 to the second frame. However, due to the disappearance in second frame 114 of the controls displayed in first frame 112, the motion vectors do not reflect actual motion of displayed objects in the displayed frames, but instead are somewhat random in nature. As such, extrapolated third frame 116 includes a variety of artifacts in application window 109, such as warping indicated at 118 and 120.

More generally, such extrapolation artifacts may arise when performing frame extrapolation based on two frames having relatively uncorrelated image data. Frames may be uncorrelated in image data when an object suddenly disappears or when an object suddenly appears, as may be the case with interactive user interfaces, or image content such as an explosion or flash of light. Other conditions that may lead to extrapolation artifacts include non-linear motion, such as when an object undergoes abrupt acceleration (e.g., as a result of collision).

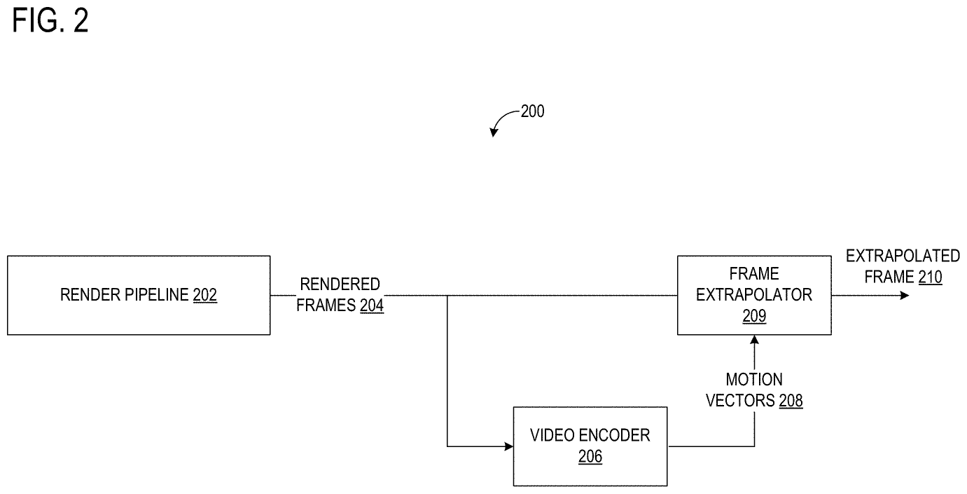

FIG. 2 shows a block diagram of a frame extrapolation pipeline 200 that may produce the artifacts illustrated in FIG. 1B. Extrapolation pipeline 200 includes a rendering pipeline 202 that produces rendered frames 204 for display. In extrapolation pipeline 200, rendered frames 204 are also provided to a video encoder 206, which produces motion vectors 208 for each block of pixels of multiple blocks of pixels in each rendered frame by comparing each block with a corresponding block in a previous rendered frame. The resulting output is a field of motion vectors, with one motion vector for each block of pixels in a rendered frame. Thus, when a target framerate for displaying rendered frames 204 cannot be met (e.g., on HMD device 100), the motion indicated by motion vectors 208 is applied by a frame extrapolator 209 to a most recently rendered frame to thereby produce an extrapolated frame 210 and maintain the target framerate.

Video encoder 206 may produce motion vectors according to a cost function designed for encoding (e.g., compressing) image data. For some image data, the cost function may lead to motion vectors that represent motion. However, for other image data, use of the cost function may lead to motion vectors that do not closely represent motion. For example, frames having significant self-similarity (e.g., patches of relatively uniform color within a single frame) may lead to motion vectors that do not represent motion when the cost function is applied to such frames. In this type of scenario, the cost function may effectively prioritize aspects of encoding (e.g., high bit rate, low file size) over the identification of motion. Artifacts may result when these motion vectors are used to extrapolate frames, in addition to motion vectors derived from uncorrelated frames as described above.

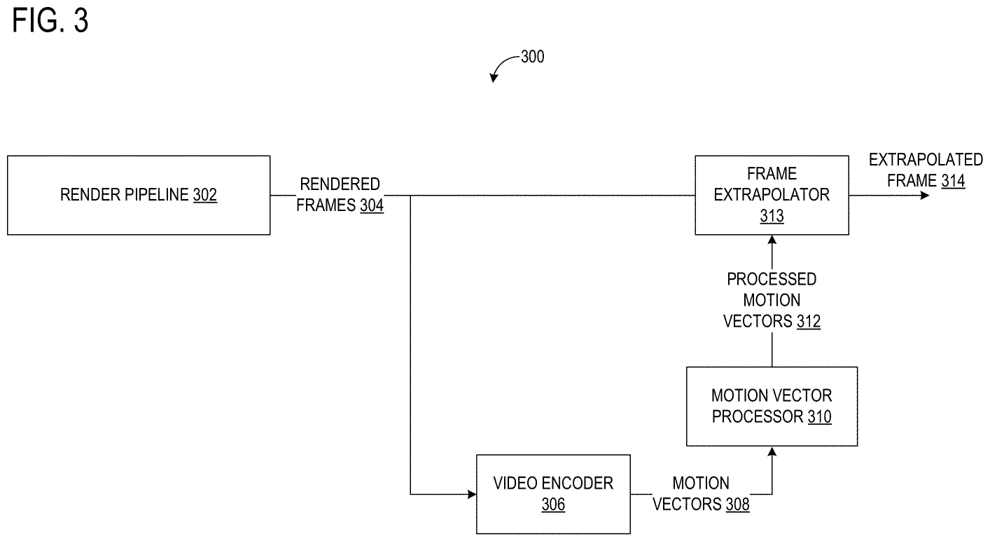

Accordingly, to mitigate the generation of extrapolation artifacts, approaches to frame extrapolation are disclosed herein that utilize motion vectors processed based on their spatial and/or temporal correspondence to other motion vectors. FIG. 3 shows a block diagram of an example extrapolation pipeline 300 configured to extrapolate frames by processing the motion vectors received from a video encoder prior to using the processed motion vectors for extrapolation.

Pipeline 300 includes a render pipeline 302 that produces rendered frames 304, which are output to a video encoder 306. Video encoder 306 produces motion vectors 308 for blocks of pixels in each rendered frame, as described above. However, motion vectors 308 are next provided to a motion vector processor 310, which produces processed motion vectors that are modified based upon a temporal correlation with prior motion vectors, and also potentially modified based upon a spatial correlation with other motion vectors in neighboring blocks of pixels in the rendered image, resulting in processed motion vectors 312. Then, when a target framerate established for displaying rendered frames 304 cannot be met, the processed motion vectors 312 may be applied by a frame extrapolator 313 to the most recently rendered frame to thereby determine predicted blocks of pixels for an extrapolated frame 314. Other framerate conditions may prompt production of extrapolated frame 314, including but not limited to a framepacing condition and a latency condition. Any suitable component, such as a scheduler at a logically higher level than the extrapolator 313, may evaluate whether the framerate condition is met.

Processing a motion vector for a block of pixels based on a temporal and potentially spatial correspondence of that motion vector to prior motion vectors for the same block of pixels may allow the processed motion vector to capture contextual information regarding the degree to which the motion vector is representative of motion and/or how random that motion is, and potentially whether the motion vector was derived from uncorrelated frames. Incorporating such contextual information, motion vector processor 310 may reduce the influence of motion vectors 308 on frame extrapolation that do not correlate strongly to motion, thereby mitigating artifacts that would otherwise result from their unprocessed use when generating predicted blocks of pixels for the extrapolated frame.

Pipeline 300 may be implemented in any suitable manner. As one example, render pipeline 302 and video encoder 306 may be implemented on a same GPU, and the motion vector processor 310 may be implemented as software. In other examples, the video encoder 306 may be implemented via hardware separate from the GPU used for the render pipeline 302. The video encoder 306 may be configured to encode image data via a specific codec, such as H.264 or H.265, as examples. In other examples, motion vectors 308 may be produced via hardware other than a video encoder (e.g., application-specific integrated circuit, field-programmable gate array), or via software, such as a video game engine, that generates the rendered image data.

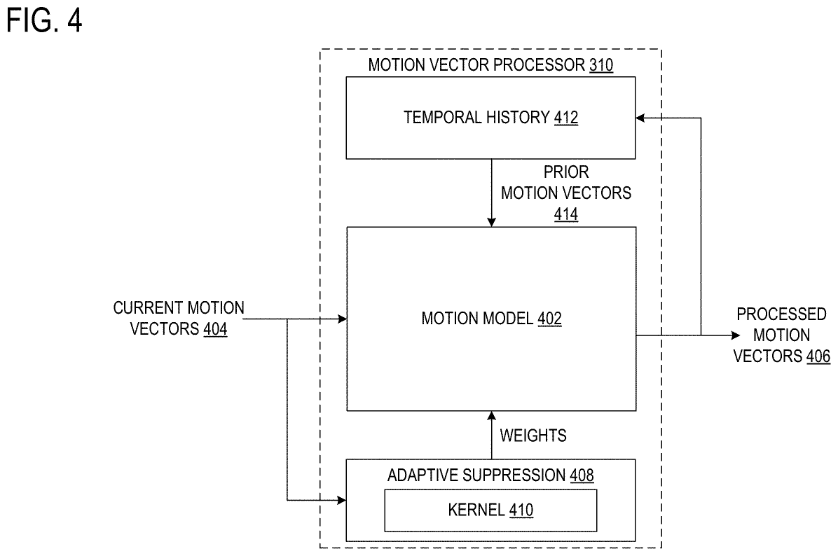

FIG. 4 shows a block diagram illustrating an example architecture for motion vector processor 310. In this example, motion vector processor 310 includes a motion model 402 configured to receive a set of current motion vectors 404 (e.g. motion vectors for each block of pixels of multiple blocks of pixels in a rendered frame) and process each motion vector based on a spatial and temporal correspondence to other motion vectors. The motion model 402 outputs a set of processed motion vectors 406, which may be used to produce an extrapolated frame.

Motion vectors 404 indicate computed motion between a current frame and a prior frame. As the current frame may be the most recently rendered frame in a sequence of frames, motion vectors 404 are referred to as “current” motion vectors.

Motion vector processor 310 is configured to consider both a temporal and spatial correspondence between motion vectors in producing processed motion vectors 406. As such, motion vector processor 310 includes an adaptive suppression module 408 configured to perform spatial comparisons of a current motion vector 404 to other motion vectors in the current frame. Such comparisons may be performed via a kernel 410, or other suitable mechanism. Kernel 410 outputs a scalar quantity related to a magnitude of correspondence between a motion vector for a block of pixels of interest and motion vectors for neighboring blocks in the same rendered frame. The resulting scalar may be used as a weighting factor for the block of pixels of interest in the computation of the processed motion vector. Further, the adaptive suppression module may actively suppress use of motion vectors that do not meet a threshold correspondence.

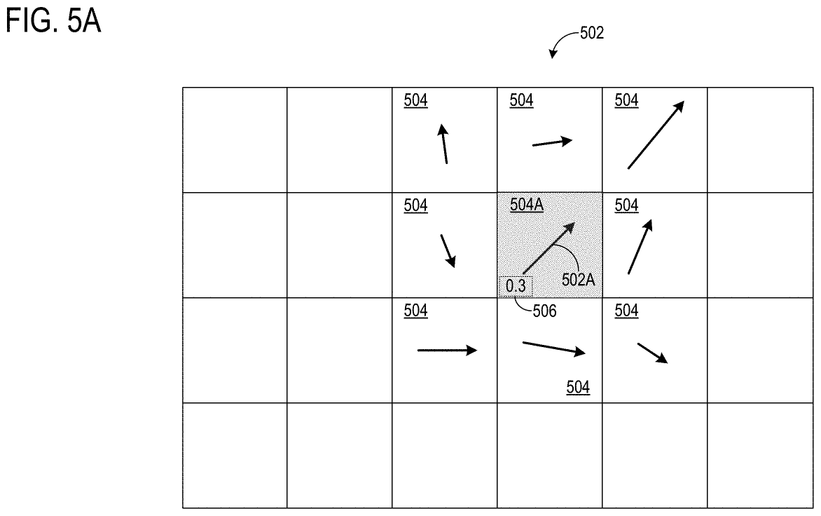

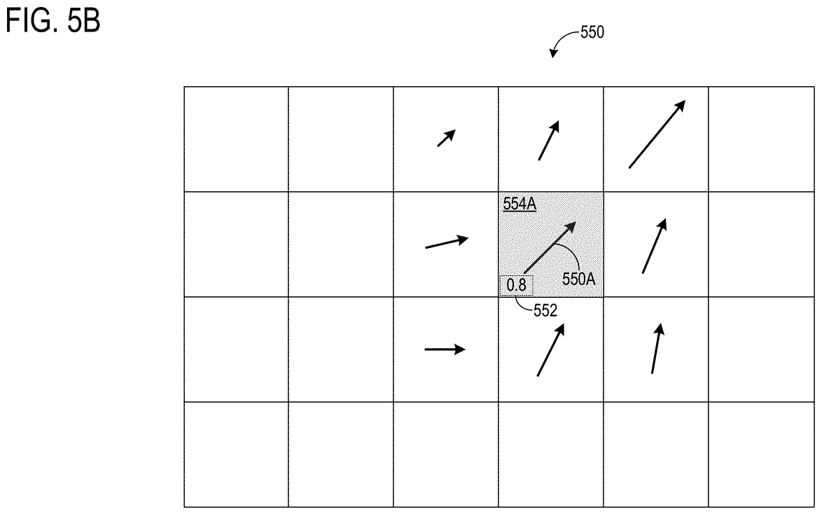

FIG. 5A illustrates one level of spatial correspondence between a motion vector 502A for a selected block of pixels 504A and motion vectors for neighboring blocks of pixels 504. Each block of pixels may include any suitable number and arrangement of pixels, such as 8×8 pixels, 16×16 pixels, a single pixel, or non-square pixel arrangements. Via kernel 410, a spatial correspondence among motion vector 502A and one or more other motion vectors in neighboring blocks 504 is determined. In the depicted example, this spatial correspondence is determined between motion vector 502A and respective motion vectors in each block 504 adjacent to block 504A, though motion vectors in any suitable number of blocks may be considered, including motion vectors in non-adjacent blocks. The assessment of spatial correspondence may take any suitable form. In some examples, the assessment may compare the direction and/or magnitude of motion vector 502A to the direction and/or magnitude of the motion vector in each adjacent block 504 (e.g., via an inner product between vectors). As mentioned above, a weight 506 is then determined based on the spatial correspondence of motion vector 502A to the one or more spatially proximate vectors. This spatial correspondence may be referred to as the “spatial coherence” of motion vector 502A. The determined weights for the block of pixels of the current frame then may be applied to current motion vectors 404 to thereby influence a contribution of each current motion vector to motion model 402 and the generation of a corresponding processed motion vector 406.

In the example of FIG. 5A, the spatial coherence of motion vector 502A to its neighboring motion vectors is relatively low, as the direction and magnitude of motion vector 502A is not highly consistent with those of the neighboring motion vectors. Thus, weight 506 assumes a relatively low value of 0.3, where weights may take on values between 0 and 1. In other examples, any other suitable range of weight values is possible, as are non-decimal and non-scalar values.

FIG. 5B illustrates another example in which the spatial correspondence of a motion vector 550A to spatially proximate motion vectors 550 is relatively high. Here, the direction and magnitude of motion vector 550A is more consistent to the respective directions and magnitudes of the surrounding motion vectors. As a result, a weight 552 having a relatively high value of 0.8 is assigned to motion vector 550A.

The examples illustrated in FIGS. 5A-5B represent how the spatial coherence of a motion vectors may be used to determine information about the motion that is represented by the motion vector. In FIG. 5A, the relative lack of spatial coherence of motion vector 502A suggests that the motion vector may not represent coordinated motion of an object or other group of pixels; instead, the motion may correspond to at least partially random motion arising from uncorrelated frames, for example. By assigning a relatively low weight to motion vector 502A, the influence of the motion vector in frame extrapolation can be reduced. In contrast, the relatively high spatial coherence of motion vector 550A suggests that the motion vector does represent coordinated pixel motion, and as such may have a significant influence in frame extrapolation.

In some implementations, if a processed motion vector determined for that block meets a discard condition, such as failing to meet a threshold weight, then the motion vector may be discarded, without being used in generating a predicted block of pixels for an extrapolated frame. With reference to FIG. 5A, motion vector 502A may be discarded (e.g., by adaptive suppression module 408) and thus not considered when updating the motion model for the current frame due to the relatively low weight assigned to motion vector 502A. It will be understood that any suitable discard condition may be applied in other examples. Further, in other implementations, instead of discarding processed motion vectors that do not meet a threshold spatial correlation, the influence of the processed motion vectors on frame extrapolation may be constrained via the weights applied to the motion vectors.

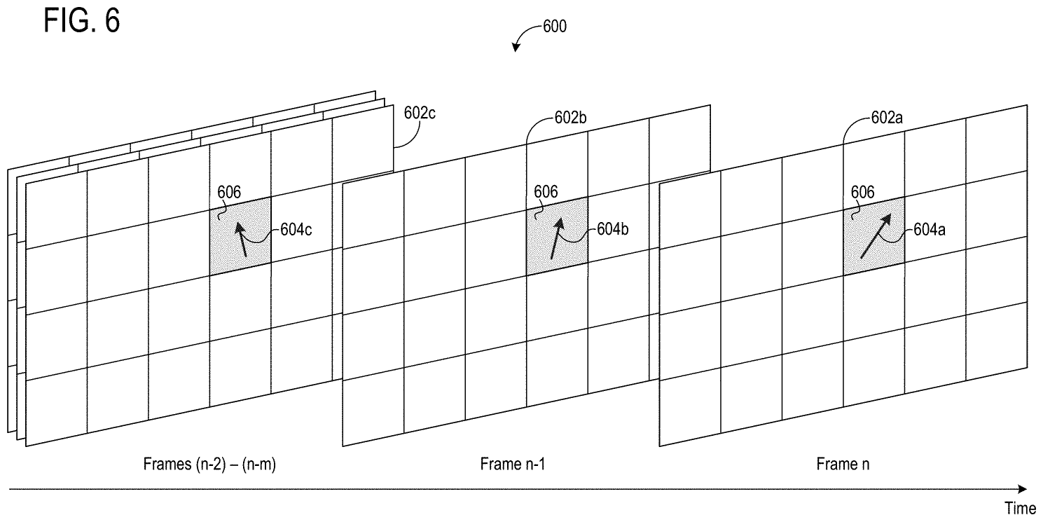

Returning to FIG. 4, motion vector processor 310 also includes a temporal history module 412 configured to accumulate a temporal history of motion vectors 406. As one example of such temporal history, FIG. 6 shows a sequence of frames 600 including a current frame 602a. In current frame 602a, a current (e.g., processed) motion vector 604a indicates motion in a block 606 between the current frame and an immediately prior frame 602b. In prior frame 602b, a prior motion vector 604b indicates prior determined motion between the prior frame and another prior frame 602c immediately preceding the prior frame. As motion vector 604b is generated based on frames that both precede current frame 602A, this processed motion vector is referred to as a “prior” motion vector. As shown in FIG. 6, prior frame 602c—as well as additional frames preceding prior frame 602c—include analogous prior motion vectors indicating motion in block 606 between corresponding pairs of frames.

FIG. 6 illustrates an example of temporal correspondence of current motion vector 604a to one or more prior motion vectors determined for the same block 606 (e.g., prior motion vector 604b, 604c, and/or other prior motion vectors determined for that block). This correspondence is captured in the processed motion vector 406 for that block by using the prior motion vectors for the block in motion model 402. By using prior motion vectors as well as the current motion vector to determine the processed motion vector for each block of pixels, the effects of motion vectors that correlate poorly with prior motion vectors may be attenuated.

Returning to FIG. 4, temporal history module 412 may capture the temporal correspondence of current and prior motion vectors by determining a weighted sum of a current weighted motion vector and prior processed motion vector(s). In one example, a weighted sum for a block may be computed according to the following function: MV_{w}=w*MV_{cur}+(1−w)*MVₚᵣᵢₒᵣ, where MV_{cur} is the current motion vector, w is the weight determined for the current motion vector, MVₚᵣᵢₒᵣ is the prior processed motion vector for that block, and MV_{w} is a weighted sum of the current and prior motion vector. In this manner, prior motion vectors exhibit an effect that decays over time as additional weighted motion vectors are accumulated in the sum. In other examples, any other suitable mechanism may be used to determine the temporal correspondence of current and prior motion vectors.

Motion model 402 receives a representation of prior motion vectors 414 (e.g., MV_{w} from the above example) from temporal history module 412. Motion model 402 may compute processed motion vectors 406 based upon the prior motion vectors 414 and current motion vectors 404. Once determined, the processed motion vectors 406 may be used to produce an extrapolated frame from a current frame.

The use of both spatial and temporal coherence in determining the processed motion vectors 406 may allow the processed motion vectors to apply motion where significant contextual information indicating such motion exists, while attenuating undesired ephemeral or random motion due to uncorrelated frames. For example, where a group of current motion vectors 404 exhibits high temporal coherence but low spatial coherence corresponding to motion of a small object, that motion may be reflected by processed motion vectors 406 several frames after establishing the temporal coherence, rather than after a single frame. Conversely, where a group of current motion vectors 404 exhibits low temporal coherence but high spatial coherence corresponding to the sudden appearance of a large object, motion model 402 may generate processed motion vectors 406 that reflect such appearance in a small number of frames. Where a group of current motion vectors 404 exhibits both low temporal and spatial coherence, such motion may not be reflected until temporal and/or spatial coherence is established over a sequence of frames. With motion model 402 configured in this manner, extrapolation pipeline 300 may be operable to produce extrapolated frames while mitigating the types of extrapolation artifacts described above.

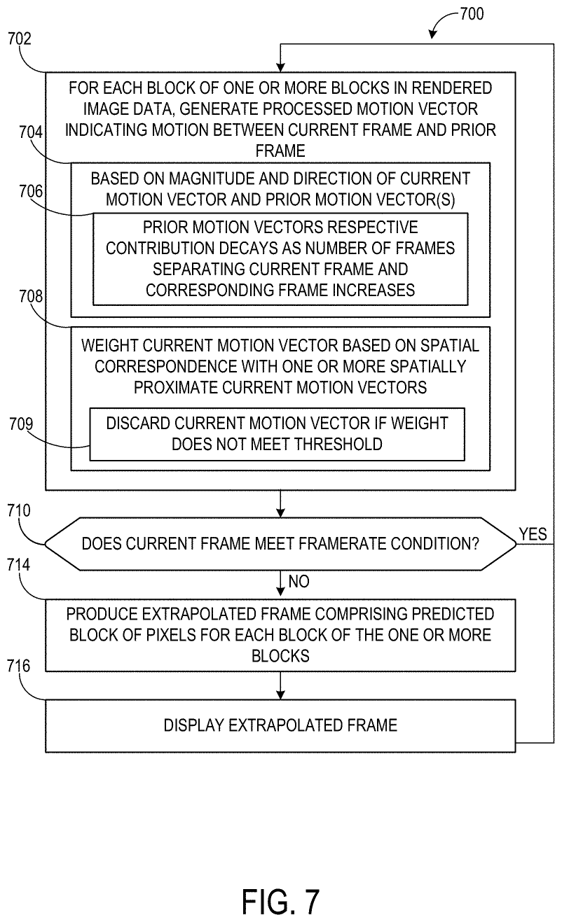

FIG. 7 shows a flowchart illustrating an example method 700 of producing an extrapolated frame. At 702, method 700 includes, for each block of one or more block of pixels in rendered image data, generating a processed motion vector indicating motion between a current frame and a prior frame. The processed motion vector may be generated based on the magnitude and direction of a current motion vector and respective magnitudes and velocities of the one or more prior motion vectors 704. The one or more prior motion vectors may be determined via one or more corresponding frames preceding the prior frame. In some examples, a respective contribution of the prior motion vectors to the predicted block of pixels may decay 706 as a number of frames separating the current frame and a corresponding frame increases. Further, in some examples, the processed motion vector may be generated using a weight 708 based on a spatial correspondence between the current motion vector and one or more current motion vectors in spatially proximate blocks. In some such examples, a current motion vector may be discarded, and thus not used to form a processed motion vector, if the weight does not meet a threshold, as indicated at 709.

At 710, method 700 includes determining whether the current frame meets a framerate condition. If it is determined that the current frame does meet the framerate condition (YES), method 700 returns to 702. If it is determined that the current frame does not meet the framerate condition (NO), indicating that a next frame will not be rendered in time for display at a target framerate, method 700 proceeds to 714. As mentioned above, in some examples, a higher level scheduler may be used to determine whether the framerate condition is met, and to trigger the extrapolation of a frame based upon this determination.

At 714, method 700 includes extrapolating a predicted block of pixels from the current frame based on the processed motion vector and producing an extrapolated frame comprising the predicted block of pixels for each block of the one or more blocks. At 716, method 700 includes displaying the extrapolated frame.

In some embodiments, the methods and processes described herein may be tied to a computing system of one or more computing devices. In particular, such methods and processes may be implemented as a computer-application program or service, an application-programming interface (API), a library, and/or other computer-program product.

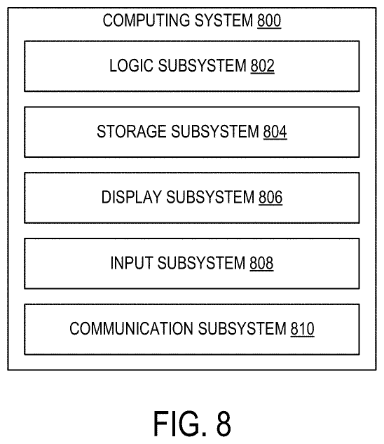

FIG. 8 schematically shows a non-limiting embodiment of a Computing system 800 that can enact one or more of the methods and processes described above. Computing system 800 is shown in simplified form. Computing system 800 may take the form of one or more personal computers, server computers, tablet computers, home-entertainment computers, network computing devices, gaming devices, mobile computing devices, mobile communication devices (e.g., smart phone), and/or other computing devices.

Computing system 800 includes a logic machine 802 and a storage machine 804. Computing system 800 may optionally include a display subsystem 806, input subsystem 808, communication subsystem 810, and/or other components not shown in FIG. 8.

Logic machine 802 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 804 includes one or more physical devices configured to hold instructions executable by the logic machine to implement the methods and processes described herein. When such methods and processes are implemented, the state of storage machine 804 may be transformed—e.g., to hold different data.

Storage machine 804 may include removable and/or built-in devices. Storage machine 804 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 804 may include volatile, nonvolatile, dynamic, static, read/write, read-only, random-access, sequential-access, location-addressable, file-addressable, and/or content-addressable devices.

It will be appreciated that storage machine 804 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 802 and storage machine 804 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of Computing system 800 implemented to perform a particular function. In some cases, a module, program, or engine may be instantiated via logic machine 802 executing instructions held by storage machine 804. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 806 may be used to present a visual representation of data held by storage machine 804. This visual representation may take the form of a graphical user interface (GUI). As the herein described methods and processes change the data held by the storage machine, and thus transform the state of the storage machine, the state of display subsystem 806 may likewise be transformed to visually represent changes in the underlying data. Display subsystem 806 may include one or more display devices utilizing virtually any type of technology. Such display devices may be combined with logic machine 802 and/or storage machine 804 in a shared enclosure, or such display devices may be peripheral display devices.

When included, input subsystem 808 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 810 may be configured to communicatively couple Computing system 800 with one or more other computing devices. Communication subsystem 810 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow Computing system 800 to send and/or receive messages to and/or from other devices via a network such as the Internet.

Another example provides a computing device comprising a logic machine, and a storage machine comprising instructions executable by the logic machine to for each block of one or more blocks of pixels in rendered image data, generate a motion vector indicating motion between a current frame and a prior frame, for each block of the one or blocks, extrapolate a predicted block of pixels from the current frame based on the motion vector and one or more prior motion vectors for the block, the one or more prior motion vectors determined via one or more corresponding frames preceding the prior frame, produce an extrapolated frame comprising the predicted block of pixels for each block of the one or more blocks, and display the extrapolated frame. In such an example, the instructions may be executed in response to detecting that the current frame does not meet a framerate condition. In such an example, the predicted block of pixels may be extrapolated alternatively or additionally based upon a magnitude and a direction of the motion vector and respective magnitudes and respective directions of the one or more prior motion vectors. In such an example, a respective contribution of each of the one or more prior motion vectors to the predicted block of pixels may decay as a number of frames separating the current frame and the corresponding frame increases. In such an example, the motion vector may be weighted with a weight, the weight determined based upon a spatial correspondence between the motion vector for the block and one or more current motion vectors in spatially proximate blocks. In such an example, the spatial correspondence may be determined via a kernel, and the kernel may be configured to output a respective weight for each of the one or more current motion vectors. In such an example, the instructions executable to generate the motion vector for each block of the one or more blocks may be executed alternatively or additionally on a video encoder. In such an example, the motion vector alternatively or additionally may be generated via an application that generates the rendered image data. In such an example, the instructions alternatively or additionally may comprise instructions executable to determine whether the motion vector for the block meets a discard condition, and not use the motion vector for generating the predicted block of pixels.

Another example provides, at a computing device, a method comprising for each block of one or more blocks of pixels in rendered image data, generating a motion vector indicating motion between a current frame and a prior frame, for each block of the one or blocks, extrapolating a predicted block of pixels from the current frame based on the motion vector and one or more prior motion vectors for the block, the one or more prior motion vectors determined via one or more corresponding frames preceding the prior frame, producing an extrapolated frame comprising the predicted block of pixels for each block of the one or more blocks, and displaying the extrapolated frame. In such an example, the method may be executed in response to detecting that the current frame does not meet a framerate condition. In such an example, the predicted block of pixels alternatively or additionally may be extrapolated based upon a magnitude and a direction of the motion vector and respective magnitudes and respective directions of the one or more prior motion vectors. In such an example, a respective contribution of each of the one or more prior motion vectors to the predicted block of pixels may decay as a number of frames separating the current frame and the corresponding frame increases. In such an example, the motion vector may be weighted with a weight, the weight determined based upon a spatial correspondence between the motion vector for the block and one or more current motion vectors in spatially proximate blocks. In such an example, the spatial correspondence may be determined via a kernel, and the kernel may be configured to output a respective weight for each of the one or more current motion vectors. In such an example, the motion vector generated for each block of the one or more blocks alternatively or additionally may be generated via a video encoder. In such an example, the motion vector alternatively or additionally may be generated via an application that generates the rendered image data. In such an example, the method alternatively or additionally may comprise determining whether the motion vector for the block meets a discard condition, and not using the motion vector for extrapolating the predicted block of pixels for the block if the discard condition is met.

Another example provides a computing device comprising a logic machine and a storage machine comprising instructions executable by the logic machine to for each block of one or more blocks of pixels in rendered image data, generate a motion vector indicating motion between a current frame and a prior frame, for each block of the one or blocks, extrapolate a predicted block of pixels from the current frame based upon a spatial correspondence between the motion vector and one or more current motion vectors in spatially proximate blocks, and also based upon a temporal correspondence between the motion vector and one or more prior motion vectors for the block, the one or more prior motion vectors determined via one or more corresponding frames preceding the prior frame, produce an extrapolated frame comprising the predicted block of pixels for each block of the one or more blocks, and display the extrapolated frame. In such an example, a respective contribution of each of the one or more prior motion vectors to the predicted block of pixels may decay as a number of frames separating the current frame and the corresponding frame increases.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device, comprising:
a logic machine; and
a storage machine comprising instructions executable by the logic machine to
for each block of one or more blocks of pixels in rendered image data, generate a motion vector indicating motion between a current frame and a prior frame;
for each block of the one or blocks, extrapolate a predicted block of pixels from the current frame based on the motion vector and one or more prior motion vectors for the block, the one or more prior motion vectors determined via one or more corresponding frames preceding the prior frame;
produce an extrapolated frame comprising the predicted block of pixels for each block of the one or more blocks; and
display the extrapolated frame.

2. The computing device of claim 1, wherein the instructions are executed in response to detecting that the current frame does not meet a framerate condition.

3. The computing device of claim 1, wherein the predicted block of pixels is extrapolated based upon a magnitude and a direction of the motion vector and respective magnitudes and respective directions of the one or more prior motion vectors.

4. The computing device of claim 1, wherein a respective contribution of each of the one or more prior motion vectors to the predicted block of pixels decays as a number of frames separating the current frame and the corresponding frame increases.

5. The computing device of claim 1, wherein the motion vector is weighted with a weight, the weight determined based upon a spatial correspondence between the motion vector for the block and one or more current motion vectors in spatially proximate blocks.

6. The computing device of claim 5, wherein the spatial correspondence is determined via a kernel, and wherein the kernel is configured to output a respective weight for each of the one or more current motion vectors.

7. The computing device of claim 1, wherein the instructions executable to generate the motion vector for each block of the one or more blocks are executed on a video encoder.

8. The computing device of claim 1, wherein the motion vector is generated via an application that generates the rendered image data.

9. The computing device of claim 1, further comprising instructions executable to determine whether the motion vector for the block meets a discard condition, and not use the motion vector for generating the predicted block of pixels.

10. At a computing device, a method, comprising:
for each block of one or more blocks of pixels in rendered image data, generating a motion vector indicating motion between a current frame and a prior frame;
for each block of the one or blocks, extrapolating a predicted block of pixels from the current frame based on the motion vector and one or more prior motion vectors for the block, the one or more prior motion vectors determined via one or more corresponding frames preceding the prior frame;
producing an extrapolated frame comprising the predicted block of pixels for each block of the one or more blocks; and
displaying the extrapolated frame.

11. The method of claim 10, wherein the method is executed in response to detecting that the current frame does not meet a framerate condition.

12. The method of claim 10, wherein the predicted block of pixels is extrapolated based upon a magnitude and a direction of the motion vector and respective magnitudes and respective directions of the one or more prior motion vectors.

13. The method of claim 10, wherein a respective contribution of each of the one or more prior motion vectors to the predicted block of pixels decays as a number of frames separating the current frame and the corresponding frame increases.

14. The method of claim 10, wherein the motion vector is weighted with a weight, the weight determined based upon a spatial correspondence between the motion vector for the block and one or more current motion vectors in spatially proximate blocks.

15. The method of claim 14, wherein the spatial correspondence is determined via a kernel, and wherein the kernel is configured to output a respective weight for each of the one or more current motion vectors.

16. The method of claim 10, wherein the motion vector generated for each block of the one or more blocks is generated via a video encoder.

17. The method of claim 10, wherein the motion vector is generated via an application that generates the rendered image data.

18. The method of claim 10, further comprising determining whether the motion vector for the block meets a discard condition, and not using the motion vector for extrapolating the predicted block of pixels for the block if the discard condition is met.

19. A computing device, comprising:
a logic machine; and
a storage machine comprising instructions executable by the logic machine to
for each block of one or more blocks of pixels in rendered image data, generate a motion vector indicating motion between a current frame and a prior frame;
for each block of the one or blocks, extrapolate a predicted block of pixels from the current frame based upon a spatial correspondence between the motion vector and one or more current motion vectors in spatially proximate blocks, and also based upon a temporal correspondence between the motion vector and one or more prior motion vectors for the block, the one or more prior motion vectors determined via one or more corresponding frames preceding the prior frame;
produce an extrapolated frame comprising the predicted block of pixels for each block of the one or more blocks; and
display the extrapolated frame.

20. The computing device of claim 19, wherein a respective contribution of each of the one or more prior motion vectors to the predicted block of pixels decays as a number of frames separating the current frame and the corresponding frame increases.
